(19) United States
(12) Patent Application Publication
(10) Pub. No.: US 2003/0150795 A1
(43) Pub. Date: Aug. 14, 2003

(54) Polymer blends and methods of separation using the same

(76) Inventors: John R. Dorgan, Golden, CO (US); Sang Yong Nam, Golden, CO (US)

Correspondence Address: HENRY E. BARTONY, JR., BARTONY & HARE, LAW & FINANCE BUILDING, SUITE 1801, 429 FOURTH AVENUE, PITTSBURGH, PA, 15219, US

(21) Appl. No.: 10/350,673

(22) Filed: Jan. 24, 2003

Related U.S. Application Data
(60) Provisional application No. 60/351,787, filed on Jan. 25, 2002.

(51) Int. Cl. B01D 71/00

(52) U.S. Cl. 210/500.21

(57) ABSTRACT

A membrane includes a blend of two or more polymers such that under operating conditions of a separation using the membrane the operating temperature is greater than at least one glass transition temperature of the blend. A membrane includes a blend of polymers exhibiting calculated δₐ of the membrane material value is greater than 7.5. A membrane includes a blend of polymers exhibiting a calculated solubility selectivity for a separation of interest greater than 1. A membrane includes a blend of polymers having polar functional groups and non-polar functional groups wherein the composition of the blend is selected so that the interaction of the polar functional groups and the non-polar functional groups with a permeating species leads to preferential solubility selectivity. A polymer blend for performing a separation includes at least one rubbery polymer having a glass transition temperature no greater than 20° C. and at least one glassy polymer having a glass transition temperature above 20° C. A method of separating components in a mixture includes the step of contacting the mixture with a membrane. The membrane includes a blend of polymers wherein under operating conditions of a separation the operating temperature is greater than at least one glass transition temperature of the blend.

### RELATED APPLICATION

This application claims the benefit of the priority of U.S. Provisional Patent Application Serial No. 60/351,787, filed Jan. 25, 2002, the disclosure of which is incorporated herein by reference.

### GOVERNMENT INTEREST

This invention was made with government support under grant DE-FC07-01ID13998 awarded by the Department of Energy. The government has certain rights in this invention.

### BACKGROUND OF THE INVENTION

The present invention relates to polymer blends or alloys for use in chemical separations and to chemical separations, including, for example, vapor separation, gas separation, pervaporation, perstraction, and reverse osmosis, using such polymer blends.

The chemical process industries expend considerable effort to separate multicomponent mixtures. In general, both raw and processed materials have multiple components but many useful products consist of a few or often only one specific chemical component. As an example, the refining of crude oil into gasoline and other products includes the steps of separating components of the crude oil as well as carrying out various chemical reactions on the components and subsequently separating the products of the reactions from one another. In the production of natural gas, the useful hydrocarbon gases come out of the ground contaminated with undesirable gases like carbon dioxide and nitrogen. The economic value of the gas is enhanced by removing the undesirable components. The food industries are also involved with chemical separations such as decaffinating coffee, removing fat from milk, and separating components of various natural oils (soy, sunflower, corn, etc.). Likewise, the pharmaceutical industries must separate valuable therapeutic components from byproducts formed during manufacturing. In addition, environmental remediation often requires the separation of pollutants from ground water. As a result of the importance of chemical separations, the field is well advanced and several separation techniques are known.

Distillation represents a method of separating liquid mixtures currently used in the chemical industry. Distillation is used most frequently to purify liquids and involves heating a liquid until it boils. The vapor is condensed and is enriched in the more volatile (lower boiling temperature) components. The process is then repeated to achieve additional separation. The condensation and reboiling is achieved in a distillation tower as is well known in the art.

Despite its widespread use, distillation suffers from considerable disadvantages. Foremost, because the fluid mixture must be heated and boiled, distillation is an extremely energy intensive process. Moreover, sometimes a reduced pressure must be imposed by creating a vacuum within the distillation tower. For permanent gases, cryogenic cooling is needed to perform distillation. The chemical process industries accounts for approximately 15-20% of total national domestic energy consumption. It is estimated that 40% of this energy use is in distillation. Accordingly, about 5% of the national energy use is consumed in separating liquids by distillation. Clearly, even marginal improvements in this technology represent enormous reductions in energy consumption. Such improvements in energy efficiency mean reduced pollution and less carbon dioxide emissions.

Pervaporation and other membrane processes represent new candidates to replace conventional separation methods with advantages of reduced capital investment and energy-savings. Additionally, cryogenic, azeotropic, and extractive distillations can be avoided using membrane separations. Pervaporation, reverse osmosis, vapor separation, and gas separation are membrane processes following a solution-diffusion mechanism in which the membrane separation selectivity is composed of diffusion selectivity and sorption selectivity. Diffusion selectivity is determined by the thermophysical properties of the separation membrane employed and the mixture of chemicals to be separated. Sorption selectivity is determined by chemical interactions and affinities between permeating species of the chemical mixture and the membrane materials. Therefore, membrane material selection is one of the most important considerations in the design and implementation of membrane processes.

Membranes with the ability to selectively separate individual chemicals from chemical mixtures have been sought for pervaporation processes to overcome the reliance on distillation and reduce the expense of chemical separations. Of particular interest are membranes capable of separating aromatics from non-aromatics in petroleum refining and chemical process plants, especially for separating aromatic hydrocarbons from saturated hydrocarbons and for recovering aromatics such as benzene, toluene, xylenes, etc. from chemical streams. Additional interest for such membranes exists in the petroleum industry for recovering aromatics from non-aromatics in heavy feed streams such as naptha, heavy cat naptha, light cat gas oil and other streams boiling in the 300° F. range. Further examples of desirable separations for membranes include the separation of more polar organic compounds from less polar organic compounds. Separation of polar components from non-polar components is desirable, for example, in the removal of pollutants from groundwater, separation of components in edible oils, and recovery of pharmaceutical compounds. Other desirable separations for membranes include separation of aromatic compounds from cyclic and aliphatic hydrocarbons and separation of ethers from alcohols.

The primary advantage of using membranes over distillation techniques is the reduced energy consumption compared to distillation. Additionally, distillation processes sometimes encounter azeotropes in which the vapor and liquid phases have the same composition. In these situations, distillation is limited to a fixed upper level concentration, for example in the separation of benzene and cyclohexane. Pervaporation processes incorporating selective membranes can separate azeotropic mixtures, and liquid mixtures with very similar boiling points without the requirement of complex unit operations. Membrane separation units may also be less costly to build and install compared to conventional distillation processes. Additionally, the use of membrane separators in conjunction with distillation in hybrid processes may offer significant cost, energy consumption, and performance advantages.

Membrane materials useful for separating aliphatics from aromatics and for effecting other separations have thus long been pursued by the industrial and scientific community. A base of technical literature exists and such materials are the subjects of a number of patents. Prior attempts to formulate membranes capable of fulfilling the roles currently played by distillation have focused primarily on diisocyanates, dianhydrides and/or urethane-based polymers. See, for example, U.S. Pat. Nos. 4,828,773, 4,861,628, 4,879,044, 4,914,064, 4,929,357, 4,983,33, 5,039,417, 5,039,418, 5,039,422, 5,049,281, 5,055,632, 5,063,186, 5,075,006, 5,096,592, 5,130,017, and 5,221,481.

Despite the significant advantages of employing polymeric membranes rather than relying on distillation or other techniques in chemical separation procedures, however, existing membranes typically suffer from rapid deterioration and low permeation rates. Thus, there exists a need for mechanically and chemically robust membranes with high permeation rates and widely adaptable separation characteristics.

### SUMMARY OF THE INVENTION

In one aspect, the present invention provides a membrane including a blend of two or more polymers such that, under operating conditions of a separation using the membrane, the operating temperature is greater than at least one glass transition temperature (T_{g}) of the blend. Under the operating conditions of the separation the membrane may be swollen with solvent, which can depress the glass transition temperature(s) of the blend. As known to one skilled in the art, a polymer blend which is not completely miscible may have more than one glass transition temperature.

In one embodiment, the membrane preferably has a calculated solubility selectivity greater than 1 using a group contribution model such as the UNIFAQ-FV model described in further detail below. More preferably, the membrane has a calculated solubility selectivity greater than 2. Even more preferably, the membrane has a calculated solubility selectivity greater than 5. Most preferably, the membrane has a calculated solubility selectivity greater than 20.

In one embodiment, the calculated polar component of the solubility parameter δₐ (described further below) of the membrane material is preferably greater than 7.5. The blend of polymers can, for example, include polar functional groups and non-polar functional groups. Preferably, the composition of the blend is selected so that the interaction of the polar functional groups and the non-polar functional groups with a permeating species leads to preferential solubility selectivity.

In selecting the polymer of the blend, at least one of the polymers of the blend can be chosen to be a rubbery polymer having a T_{g} at atmospheric pressure less than 20° C., and at least one other of the polymers of the blend can be chosen to be a glassy polymer having a T_{g} at atmospheric pressure greater than 20° C. In one embodiment, the rubbery polymer has a T_{g} less than 0° C. at atmospheric pressure. The glassy polymer can have a T_{g} greater than 50° C. at atmospheric pressure. Likewise, the glassy polymer can have a T_{g} greater than 100° C. at atmospheric pressure. In another embodiment, the blend of polymers includes a first rubbery polymer having a T_{g} at atmospheric pressure less than 20° C. and at least a second rubbery polymer having a T_{g} at atmospheric pressure less than 20° C. In a further embodiment, the blend of polymer includes a first glassy polymer having a T_{g} at atmospheric pressure greater than 20° C. and at least a second glassy polymer having a T_{g} at atmospheric pressure greater than 20° C.

Polymers used in the polymer blends of the present invention preferably have a number average molecular weight above approximately 500. In general, the polymers used to form the polymer blends of the present invention preferably have a number average molecular weight in the range of approximately 500 to approximately 500,000. More preferably, the molecular weight is in the range of approximately 2500 to approximately 350,000. Most preferably, the molecular weight is preferably between approximately 5,000 and approximately 250,000.

Rubbery polymers suitable for use in the blends of the present invention include, but are not limited to, acrylonitrile butadiene rubber, styrene butadiene rubber, natural rubber, polybutadiene, polyisoprene, halogenated polybutadiene; chlorinated polyethylene, chlorosulfonated polyethylene, poly(epichlorohydrin), polybutylmethacrylate, poly(dimethylsiloxane), polydimethylphenylsiloxane, functionalized polysiloxanes, flurosiloxane rubber, hydrogenated acrylonitrile butadiene copolymer, acylonitrile-butadiene-styrene copolymer, isoprene-isobutylene copolymer, halogenated isoprene-isobutylene copolymer, ethylene-propylene copolymer, ethylene-propylene-diene copolymer, ethylene-vinylacetate copolymer, acrylic rubber, ethylene-acrylate copolymer, epichlorihydrin-ethylene oxide copolymer, copolymers of epichlorihydrin and ethylene oxide with poly(epichlorohydrin) blocks, polypropylene oxide rubber, copolymers of hexafluoro propoylene, tetrafluro ethylene, 1-hydropentafluoro propylene, and perfluoro(methylvinylether), alkylenesulfide rubber, or polysiloxane copolymers of dimethyl siloxane, dimethylphenylsiloxane, and vinyl siloxane.

At least one of the polymers can, for example, be chosen to improve mechanical properties of the membrane. Moreover, at least one of the polymers can be chosen to control the polarity of the membrane. At least one of the polymers can, for example, be a glassy thermoplastic having polar characteristics and a glass transition temperature greater than about 20° C. Such a glassy polymer can impart both mechanical strength and increase the polar components of the solubility parameter.

Examples of glassy polymers suitable for use in the polymer blends of the present invention include, but are not limited to, poly(vinyl chloride), polystyrene, polyacylonitrile, poly(vinylidenechloride), copolymers of poly(vinylidenechloride) and polyvinylchloride, poly(vinylidenefluoride), polyvinylfluoride, an acrylic polymer, polyvinyl acetate, a polyamide, a polyimide, a polyester, a polyether, poly(phenylene sulfide), a polysulfone, a polysulfide, or a polyether sulfone.

Preferably at least one of the polymers of the blend is crosslinked to form a polymer network. Such crosslinking can increase both mechanical robustness and chemical robustness or resistance. One of the polymers can, for example, be crosslinked in a manner to encapsulate or otherwise retain the other polymer(s) of the bend within the resultant network. Also, more than one of the polymers or all of the polymers of the membrane can be crosslinked to form a polymer network incorporating more than one of or all of the polymers. The polymer blend of the present invention can also be retained in the form of a membrane, film or other geometry through other means such as encapsulation within or deposition upon another material.

In several embodiments, the membranes of the present invention include a ternary blend of polymers. For example, the blend of polymer can include a first rubbery polymer, a second rubbery polymer and a glassy polymer. The rubbery polymers can, for example, be chosen to result in a desired glass transition temperature for the membrane as well as to include functional groups to provide a desired selectivity. The glassy polymer can be chosen to, for example, impart mechanical strength as well as to include function groups to provide a desired selectivity.

In one embodiment, the polymer blend comprises acrylonitrile butadiene rubber, styrene butadiene rubber and poly(vinyl chloride). Preferably, at least one of these polymers is crosslinked to from a polymer network as described above. Preferably, acrylonitrile butadiene rubber is present in the range of about 0.1 weight fraction to about 1 weight fraction in the membrane. The acrylonitrile butadiene rubber preferably includes at least about 15% acrylonitrile content. Styrene butadiene rubber is preferably present within the membrane in the range of about 0.01 weight fraction to about 0.5 weight fraction. The styrene butadiene rubber preferably includes at least about 20% styrene content. Poly(vinyl chloride) is preferably present in the membrane in the range of about 0.01 weight fraction to about 0.9 weight fraction. The poly(vinyl chloride) preferably has a number average molecular weight of at least about 30,000. The calculated δₐ value of the membrane is preferably greater than 7.5.

In one embodiment the membrane includes between about 0.1 weight fraction and about 1 weight fraction of acrylonitrile butadiene rubber, between about 0.01 weight fraction and about 0.5 weight fraction of styrene butadiene rubber, and between about 0.01 weight fraction and about 0.9 weight fraction of poly(vinyl chloride). In general, the weight fractions of the polymer components of this embodiment and other embodiment of the present invention can be elected for separation of aromatic hydrocarbons from mixtures of aromatic and non-aromatic hydrocarbons.

Preferably, the membranes of the present invention have a permeation rate for a separation of a 50:50 benzene-cyclohexane mixtures at 25° C. of at least 2 kg μm/m² hr. More preferably, the permeation rate is at least 5 kg μm/m² hr. Even more preferably, the permeation rate is at least 10 kg μm/m² hr. Most preferably, the permeation rate is at least 20 kg μm/m² hr.

Preferably, the membranes of the present invention have a separation factor value for a separation of a 50:50 benzene-cyclohexane at 25° C. of at least 4. More preferably, the separation factor value is at least 10.

The membranes of the present invention can, for example, include an inorganic filler material chosen to reduce flux through the membrane and to increase selectivity.

In another aspect, the present invention provides a membrane including a blend of polymers exhibiting a calculated δₐ value greater than 7.5.

In another aspect, the present invention provides a membrane comprising a blend of polymers exhibiting a calculated solubility selectivity for a separation of interest greater than 1. As discussed above, the membrane more preferably has a calculated solubility selectivity greater than 2. Even more preferably, the membrane has a calculated solubility selectivity greater than 5. Most preferably, the membrane has a calculated solubility selectivity greater than 20.

In a further aspect, the present invention provides a membrane including a blend of polymers having polar functional groups and non-polar functional groups wherein the composition of the blend is selected so that the interaction of the polar functional groups and the non-polar functional groups with a permeating species leads to preferential solubility selectivity.

In another aspect, the present invention provides a polymer blend for performing a separation including at least one rubbery polymer having a glass transition temperature no greater than 20° C. and at least one glassy polymer having a glass transition temperature above 20° C.

In still a further aspect, the present invention provides a method of producing a polymer alloy capable of separating chemical components. The polymer alloy includes a polymer blend of at least one of acrylonitrile butadiene rubber and styrene butadiene rubber, and poly(vinyl chloride). The method includes steps: dissolving at least one of acrylonitrile butadiene rubber and styrene butadiene rubber with poly(vinyl chloride) in a solvent to form a polymer solution; adding at least one compound to the polymer solution to form a casting solution; casting the casting solution to form a cast polymer; evaporating the solvent from said cast polymer to form a polymer film; and, crosslinking the polymer film to form a cast polymer alloy.

Sulfur, 2,2′-dithiobisbenzothiazole and zinc oxide can, for example, be added to the polymer solution to form a casting solution. Preferably, the polymer solution includes between about 0.1 weight fraction and about 1 weight fraction of acrylonitrile butadiene rubber, between about 0.01 weight fraction and about 0.5 weight fraction of styrene butadiene rubber, and between about 0.01 weight fraction and about 0.9 weight fraction of poly(vinyl chloride).

The solvent used can, for example, be cyclohexanone, tetrahydrofuran, dichloromethane or butanone. Preferably, the concentration of the polymer solution is between about 1 weight percent and about 50 weight percent.

The casting solution can, for example, be cast onto a glass, metal, plastic, ceramic or other type of flat or curved surface to form a liquid film. The casting solution can also be cast into an asymmetric porous membrane. The casting step can also include solution spinning to form a hollow fiber membrane. Likewise, the casting step can include melt spinning to form a hollow fiber membrane. Further, the casting step can include continuous extrusion and curtain or other forms of continuous coating.

The evaporating step can include heating the cast polymer at a temperature between about 25° C. and about 100° C. The crosslinking step can, for example, include heating the polymer film to a temperature between about 70° C. and about 180° C. More preferably, the polymer film is heated to a temperature between about 100° C. and about 150° C. in the crosslinking step. Preferably, the polymer film is heated in the crosslinking step for a period of time ranging from about 1 minute to about 200 minutes.

The crosslinking step can also be accomplished via chemical crosslinking by the addition of a member of the group consisting of peroxides, sulfur, sulfur-containing agents, zinc oxide, and zinc stearate. The crosslinking step can, for example, include a variation of chemical crosslinking such as sulfur vulcanization, carbamate modified crosslinking and UV-crosslinking. Alternatively, the crosslinking step can include a variation of radiation crosslinking selected from the group consisting of gamma radiation, electron beam, and x-ray crosslinking.

The casting step can include depositing the casting solution on a substrate to form a composite polymer membrane material. In one embodiment, the substrate includes a material selected from the group consisting of metals, glasses, ceramics, other polymers and mixtures thereof.

In still another aspect, the present invention provides a method of producing a polymer alloy capable of separating chemicals comprising a polymer blend of at least one of acrylonitrile butadiene rubber and styrene butadiene rubber and poly(vinyl chloride). The method includes the steps of: melting the polymer blend; processing the melted polymer blend to form a membrane; and crosslinking the membrane. The melted polymers can be formed into a selected geometry. For example, the melted polymers can be formed into a film, a sheet, or hollow fibers.

In still a further aspect, the present invention provides a method of separating components in a mixture including the step of contacting the mixture with a membrane. The membrane includes a blend of polymers wherein under operating conditions of a separation the operating temperature is greater than at least one of the glass transition temperatures of the blend. The separation of the components of the mixture can, for example, be effected based at least in part upon differences in solubility of the components to be separated in the membrane. In one embodiment, aromatic hydrocarbon components are separated from non-aromatic hydrocarbon components. In another embodiment, polar components are separated from less polar components. In still another embodiment, the components to be separated are gases. An example of a membrane suitable for use in the method of the present invention includes a polymer blend of acrylonitrile butadiene rubber, styrene butadiene rubber, and poly(vinyl chloride) as described above.

As used herein, the term “polymer” refers generally a large molecule made up of repeating units and includes natural and synthetic polymers. The polymers can be linear, branched, radial, ladder or even cyclic polymers. The term polymer encompasses homopolymers in which the repeat units are created generally through the polymerization of a single monomer as well as copolymers which contain two or more different monomers. The monomers in a copolymer can be arranged randomly or in blocks. As used herein, the term “glass transition temperature” or “T_{g}” refers generally to a temperature at which a polymer goes from being glassy (having a shear modulus of about 1 Gigapascal) to rubbery (having a shear modulus of about 1 Megapascal). Rubbery behavior is exhibited at temperatures above the glass transition and glassy behavior is exhibited at temperatures below the glass transition temperature As used herein, the term “glassy polymer” refers generally to a polymer below its glass transition temperature, while the term “rubbery polymer” refers to a polymer that is above its glass transition temperature. The term “crosslinking” refers to a chemical reaction or physical process leading to the formation of a molecular network. In the case of a blend of two or more polymers, one, two or more of the polymers in the blend can react to become crosslinked within the network.

As used herein, the term “monomer” refers to a molecule capable of reacting with itself or with other monomer(s) to form a larger molecule. Examples include styrene, butadiene, acrylonitrile, and vinyl chloride. Nitrile (or acrylonitrile) butadiene polymer (NBR) is a rubbery polymer that includes acrylonitrile and butadiene monomers arranged in any molecular architecture including linear, branched, radial, ladder, and cyclic. Styrene butadiene polymer (SBR) is a rubbery polymer that includes styrene and butadiene monomers arranged in any molecular architecture including linear, branched, radial, ladder, and cyclic. Poly(vinyl chloride) is a glassy polymer that is a homopolymer synthesized by the polymerization of vinyl chloride monomer.

As used herein, the term “perstraction” refers generally to a separation process involving the selective dissolution of particular components contained in a mixture into a membrane, the transport of those components through the membrane and the removal of the transported components from the downstream side of the membrane by use of a liquid sweep stream. As used herein, the term “pervaporation” refers generally to a separation process in which a vacuum is created on the permeate side of a membrane to evaporate the permeate from the surface of the membrane and maintain the concentration gradient driving force which drives the separation process. As used herein, the term “permeate” refers generally the stream of chemical components that has passed through a membrane.

As described above, the present invention provides polymeric blends or alloys useful as separation membranes and methods of use thereof. The polymer blends of glassy polymers and rubbery polymers of the present invention are capable of separating molecular species when employed in separation methods including, for example, vapor separation, gas separation, pervaporation, perstraction, and reverse osmosis.

The polymer blends of the present invention can, for example, be designed and even optimized for the separation of aromatic hydrocarbons from mixtures of aromatic hydrocarbons and non-aromatic hydrocarbons. For example, benzene is readily separated from cyclohexane using the polymer blend membranes of the present invention. Other aromatic hydrocarbons that are separable from saturated hydrocarbons using the polymer blends of the present invention include, toluene, xylenes, ethylbenzene, etc. The polymer blend membranes of the present invention are also useful for separating polar components from non-polar ones. Other examples of separations for which the polymer blend membranes of the present invention are suitable include aromatic hydrocarbons from cyclic and aliphatic hydrocarbons and separation of ethers from alcohols. Likewise, the polymer blend membranes of the present invention are also useful for separating gaseous mixtures (for example, the separation of nitrogen from methane and natural gas).

The polymer blends of the present invention exhibit good mechanical strength and good chemical resilience for use in chemical separations. In that regard, the polymer blend membranes of the present invention are much more chemically and mechanically robust than currently available membranes fabricated using, for example, diisocyanates, dianhydrides or urethane-based polymers. In general, the polymer blend membranes of the present invention do not deteriorate or break when placed into service for extended periods of time.

The polymer blend membranes of the present invention also exhibit higher rates of flux than has previously been possible with, for example, diisocyanate, dianhydride, or urethane-based separation membranes. In the polymer blends of the present invention, one or more the rubbery polymers thereof is preferably above its glass transition temperature during operation. Preferably, the alloy itself has at least one glass transition temperature below the operating temperature. Flux through a polymer above the glass transition is greater than through a corresponding glassy polymer. As such, the polymer blends of the present invention allow the design and production of polymer membranes for chemical separation having higher chemical flux properties than separation membranes currently available.

In general, the polymer blends of the present invention can be predictively formulated to display a wide range of properties for diverse separation applications. Using blends of polymers to create an alloy allows realization of properties not possible with single component materials.

### BRIEF DESCRIPTION OF THE DRAWINGS

FIG. 1A illustrates the chemical structure of the repeat units of NBR, SBR and PVC polymers.

FIG. 1B illustrates schematically a system used in pervaporation studies of the present invention.

FIG. 2 illustrates mass update of components in one polymer blend (712) of the present invention.

FIG. 3A illustrates the effects of blend composition on equilibrium swelling for various benzene/cyclohexane feed concentrations as a function of NBR content.

FIG. 3B illustrates the effects of blend composition on equilibrium swelling for various benzene/cyclohexane feed concentrations as a function of PVC content.

FIG. 4 illustrates benzene/cyclohexane selectivity as a function polar components of the solubility parameter.

FIG. 5 illustrates pervaporation selectivities for a series of polymer blend membranes of the present invention.

FIG. 6 illustrates pervaporation results for one polymer blend (316) of the present invention.

FIG. 7 illustrates pervaporation selectivity as a function of polar solubility parameter.

FIG. 8 illustrates pervaporation selectivity as a function of calculated solubility selectivity.

FIG. 9 illustrates a flow chart of an example of an iterative process for the calculation of solubility selectivity for a NBR-SBR-PVC membrane with a 50:50 mixture of benzene and cyclohexane.

### DETAILED DESCRIPTION OF THE INVENTION

As described above, many rubbery polymers and/or glassy polymers are suitable to create blends or alloys of rubbery polymer(s) and glassy polymer(s) to effect chemical separations in the present invention. In general, organics diffuse rapidly through rubbery materials so the productivity is high. Control over the selectivity in the polymer blends of the present invention results primarily from differences in solubility resulting from the proper selection of the blend formulation. The solubility characteristics or parameters of the polymer blends of the present invention can be controlled by appropriately blending polymers having different properties as described below. In addition, proper blending can have favorable effects on diffusion selectivity.

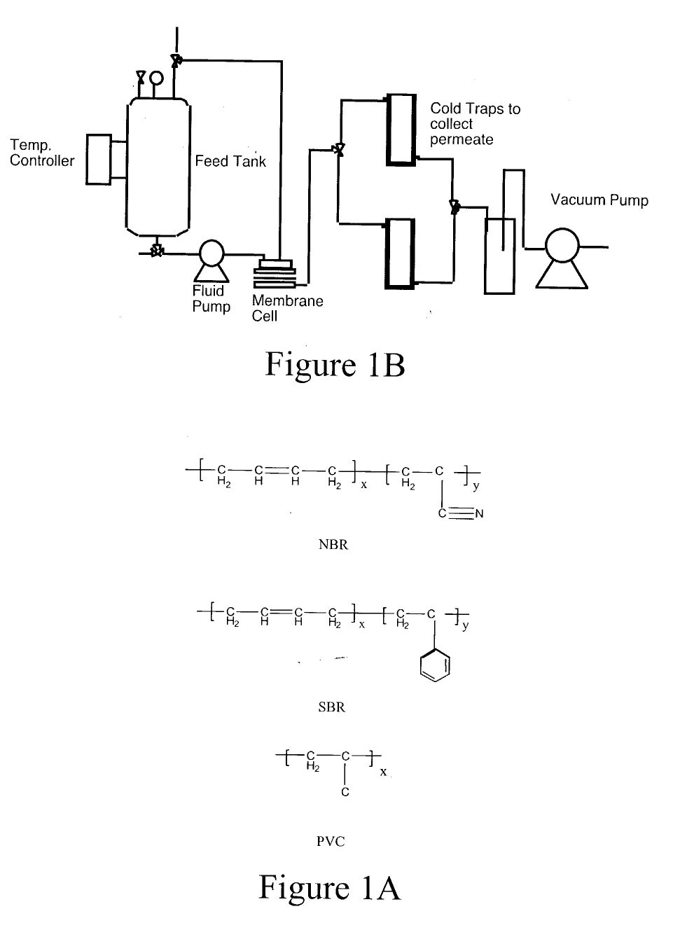

A membrane system including a ternary blend of styrene butadiene rubber (SBR) copolymer, acrylonitrile butadiene rubber (NBR) copolymer, and polyvinylchloride (PVC) is discussed herein as a representative embodiment of the present invention in representative pervaporation and gas separation studies. This polymer blend has a wide range of miscibility. Additionally, the blend possesses solvent resistance and heat resiliance. NBRs and SBR used in the representative blends of the present studies were provided by Nippon Zeon and had 41.5, 28, 18% acrylonitrile content and 23.5% styrene content, respectively. PVC homopolymer used in the blends of the present invention was purchased from Aldrich Chemical Company. The chemical structures of the repeat units for NBR, SBR and PVC are set forth in FIG. 1A.

In several studies, NBR, SBR and PVC were dissolved in a solvent such as cyclohexanone to prepare a polymer blend solution of known composition as described further below. Prepared blend samples were designated numerically as parts NBR, SBR, PVC. For example, 712 represents a polymer blend containing 70wt % NBR, 10 wt % SBR and 20 wt % PVC. Crosslinking agents and, when necessary, activator and accelerator, were added into the solution. The solution was cast onto a glass plate and dried in a fume hood for apporximately 1 day (16-24 hours). The cast membrane film was crosslinked under vacuum in an oven at 130° C. for 80 minutes.

Pervaporation Studies

Screening of blend formulations was accomplished by simple swelling tests. Prepared membrane samples were massed and subsequently submerged into solvent in sealed Erlenmeyer flasks with agitation provided by a shaker table for 1 day at 25° C. Upon removal, the samples were blotted dry using a Kimwipe paper towel and immediately massed. The swelling ratio (SR) of the polymer blend membranes of the present invention was calculated using following equation,

$$Swelling Ratio = \frac{{W}_{d} - {W}_{s}}{{W}_{d}} \times 100 \qquad ( 1 )$$

where W_{d} and Wₛ are the weight of dry and swollen samples, respectively.

Pervaporation experiments were carried out with laboratory scale equipment including a Millipore membrane holder having an effective membrane area in contact with the feed liquid of 13.8 cm² as illustrated in FIG. 1B. The feed liquid was continuously circulated from and returned to a 3 L reservoir. Downstream pressure was maintained below 5 torr, typically at about 2 torr. After an equilibration period of at least 6 hours, permeate was collected at constant time intervals by means of freezing in a liquid nitrogen cooled cold finger. Analysis of feed and permeation stream compositions was performed by Gas Chromatography—Mass Spectrometry (Agilent GC-MASS G2570A) and checked by simple refractive index measurements.

A separation factor (α) and a permeation rate were defined as follows in Equations 2 and 3.

$$\begin{matrix}α = \frac{{w}_{P , Benzene} / {w}_{P , cyclohexane}}{{w}_{F , Benzene} / {w}_{F , cyclohexane}} & ( 2 ) \\ Permeation Rate = Q = \frac{q \times L}{A \times t} & ( 3 )\end{matrix}$$

In Equation 2, w_{P,i} is the weight fraction of component i in permeate and w_{F,i} is the weight fraction of component i in the feed. In Equation 3, Q is the normalized flux or permeation rate where q, L, A and t represent the mass of collected permeate (kg), membrane thickness (μm), membrane area (m²) and operating time (in hours), respectively.

The theoretical approach taken in the present invention rests on the transport mechanism of pervaporation following the solution-diffusion mechanism. The relevant quantitative relationship is given by Equation 4.

$${J}_{i} = \frac{{D}_{i}}{L} ( {c}_{i0 , m} - {c}_{iL , m} ) = \frac{{D}_{i} {K}_{i}^{gas}}{L} ( {p}_{i0} - {p}_{iL} ) = \frac{{P}_{i}}{L} ( {p}_{i0} - {p}_{iL} ) \qquad ( 4 )$$

In Equation 4, Jᵢ represents the flux of species i, D is diffusivity, L is the thickness of the membrane, and C_{i),m} represents the concentration of the species internal to the membrane at position 0, whereas C_{iL,m} represents the concentration internal to the membrane at position L. Kᵢ^{gas} is a gas phase sorption coefficient that allows reference to the concentrations external to the membrane via the partial pressures on either side of the membrane, pᵢ₀ and P_{iL}. Finally in Equation 4, the gas permeability coefficient, Pᵢ, is defined as the product of Dᵢ and Kᵢ^{gas}.

For complete thermodynamic generality, the concentration internal to the membrane is related to the concentration external to the membrane by the quality of chemical potentials (μ),

μ_{i,m}=μᵢ (5)

Equation 5 is the rigorous basis for the form presented in Equation 4. Equation 4 reveals the basic physics exploited by the present approach. Namely, blending is performed to maximize the difference in the product of DᵢKᵢ or in the case of solubility selectivity being dominant, directly in the values for c_{i0,m}. A fuller discussion of the quantitative methodology used to accomplish this goal is described below.

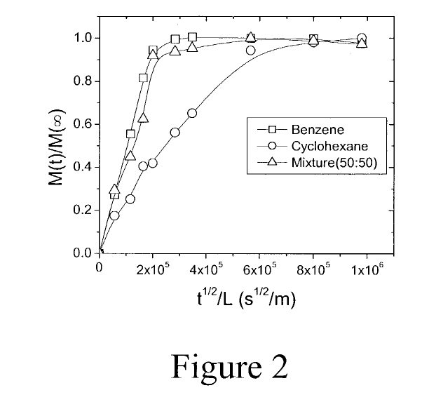

Swelling kinetics are of interest for many reasons. A simple experiment is used to both determine the time needed to equilibrate the rubber and to determine diffusion coefficients for the pure solvents. Kinetics of mass uptake for benzene, cyclohexane, and a 50:50 weight mixture of the two are presented in FIG. 2 for a 712 blend. Equilibrium swelling was achieved within 4 hours. Diffusion coefficients for benzene and cyclohexane in the blend were 1.12×10⁻¹² m²/sec and 1.92×10⁻¹¹ m²/sec, respectively. Published diffusion coefficient data for benzene in natural rubber is 1×10⁻¹¹ m²/sec while the value for benzene in PVC is 3×10⁻⁷ m²/sec. Accordingly, the values determined are within reasonable bounds.

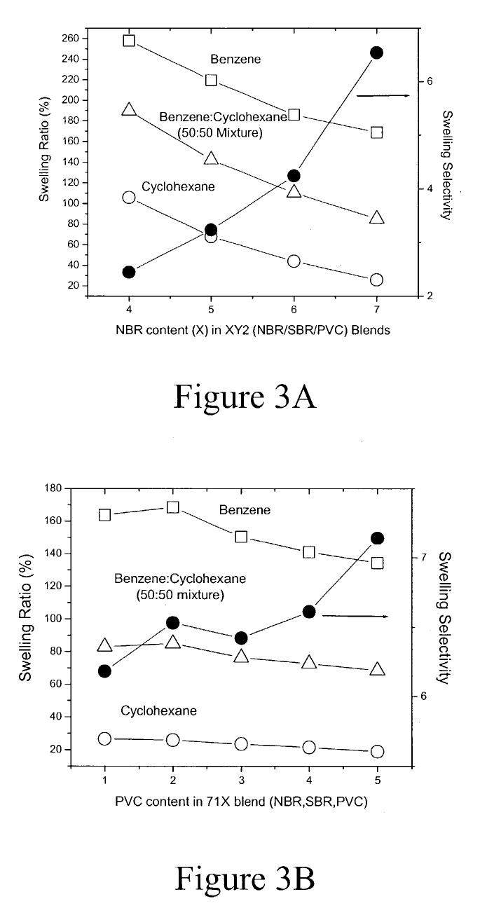

Knowing that the blends are equilibrated, a systematic investigation of the relationship between swelling and blend composition was undertaken. FIG. 3A shows the results of swelling tests performed as the NBR content increases, while FIG. 3B shows the results of swelling tests as PVC content increases in two series of blends. When the content of NBR was increased, the swelling of both benzene and cyclohexane were decreased. However, the ratio of benzene swelling to swelling by cyclohexane (the swelling selectivity) increased. The same was true for blends in which the PVC content was increased. These results can be explained in that NBR and PVC are polar in nature and thus preferentially solubilize benzene to cyclohexane.

The results of FIGS. 3A and 3B can be empirically described by utilizing the concept of the solubility parameter. This physical quantity is described for a low molecular weight compound according to Equation 6.

$$δ = {( \frac{{E}_{coh}}{V} )}^{1 / 2} = {( \frac{Δ {H}_{VAP} - RT}{V} )}^{1 / 2} \qquad ( 6 )$$

Here, δ is the solubility parameter, E_{coh} is the cohesive energy, V is volume, ΔH_{VAP} is the enthalpy of evaporation, R is the gas constant, and T is temperature. For polymers, the solubility parameter can be defined as equal to the value of the solvent that produces the maximum degree of swelling in a crosslinked version.

The solubility parameter is a useful guide for understanding the solubility of one component in another. Similar values of solubility parameter indicate mutual miscibility or compatibility. The total solubility parameter, δ, may be divided into three categories; contributions resulting from dispersion forces, δ_{d}, polar forces δₚ, and hydrogen bonding contributions, δ_{H}. Systems including a mixture of aromatics and aliphatics, ethers and alcohols, etc., can exhibit big differences in the polar and hydrogen bonding solubility parameters. Blending of polymers in the present invention allows for control of the various component values of the total solubility parameter. In the present studies, it is convenient to define a parameter, δₐ, according to Equation 7.

δₐ²=δₚ²+δₕ² (7)

The δₐ parameter defined here in terms of available handbook values has been found to correlate strongly with the electrostatic components of the solubility parameter derived from molecular dynamics simulations.

In addition, a simple blending rule for solubility parameters of the blends in the form of Equation 8 is also utilized,

$${δ}_{a , Blend} = {\sum }_{i} {ϕ}_{i} {δ}_{a , i} \qquad ( 8 )$$

where φᵢ represents the volume fraction of species i.

Preferably δₐ values in excess of 7.5 were exhibited by the polymer blends of the present invention. In that regard, denoting the weight fraction of the NBR with x, that of SBR by y, and that of PVC by z, the values of x are preferably between 1 and 0.1, the values of y are preferably between 0.5 and 0 and the values of z are preferably between 0.9 and 0. For example, in the specific separation of benzene from cyclohexane, the preferred values of z are between 0.3 and 0.6. Table 1 gives numerical values for the performance characteristics of the various membrane materials of the present invention for a 50:50 feed of benzene and cyclohexane at 25° C.

TABLE 1

| | Permeation | Separation | δₐ |
|---|---|---|---|
| Alloy | Rate(kg μm/m² hr) | Factor | MPa^{1/2} |
| 712 | 16.2 | 5.9 | 8.6 |
| 442 | 46.0 | 4.0 | 7.2 |
| 424 | 10.0 | 9.1 | 8.0 |
| 316 | 5.0 | 13.1 | 8.3 |
| 415 | 6.8 | 10.3 | 8.4 |
| 613 | 8.4 | 7.5 | 8.5 |
| 910 | 32.0 | 4.2 | 8.8 |

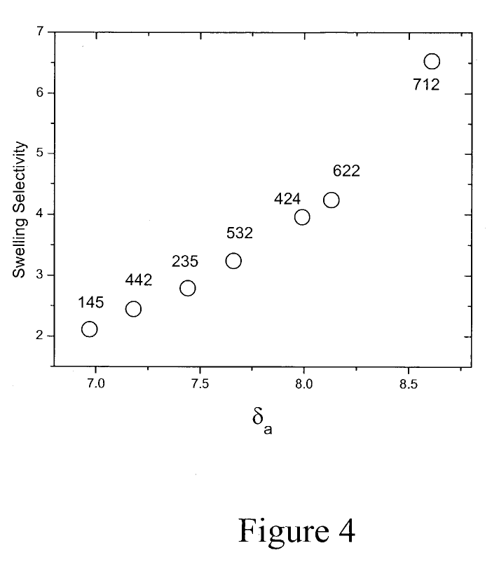

FIG. 4 presents the measured swelling selectivities as a function of the calculated polar components of the solubility parameter (δₐ) for several different polymer blends of the present invention. From FIG. 4 it can be seen that a reasonably quantitative relationship between solubility selectivity and the polarity of the polymer blend does exist. This relationship establishes a design heuristic for the separation of benzene from cyclohexane and related systems, namely, the blend should be made as polar as possible.

The data of FIG. 4 indicate that the solubility parameter approach can be limited in predictive capability, however. In that regard, several blends have δₐ values around 8.6 MPa^{1/2} but significantly different swelling selectivities. Accordingly, while solubility parameters are an easy way to screen blend materials, they may not provide a rigorous, quantitative predictive capability.

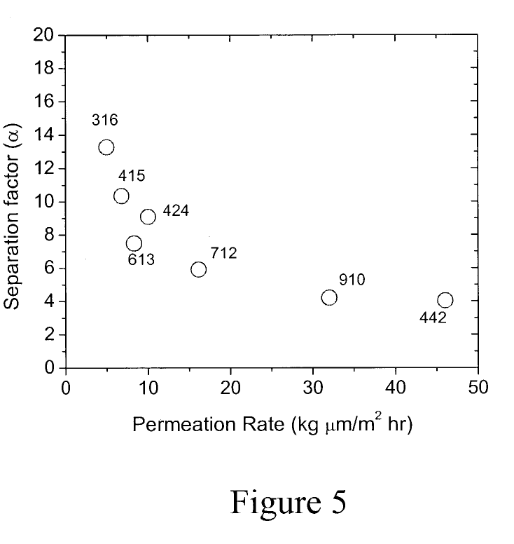

Pervaporation results for a 50:50 by weight mixture of benzene and cyclohexane are exhibited in FIG. 5. In FIG. 5, the selectivity factor, α, defined by Equation 2 is plotted against the permeation rate defined by Equation 3. A typical tradeoff curve is found with fluxes increasing as selectivity decreases. It the plot of FIG. 5 each point represents a different blend composition having a distinct performance. The high permeation rates of the studies of FIG. 5 are particularly significant. In principle, a 10 μm permselective layer could produce between 0.5 and 5.0 kg/m²hr at 25° C.

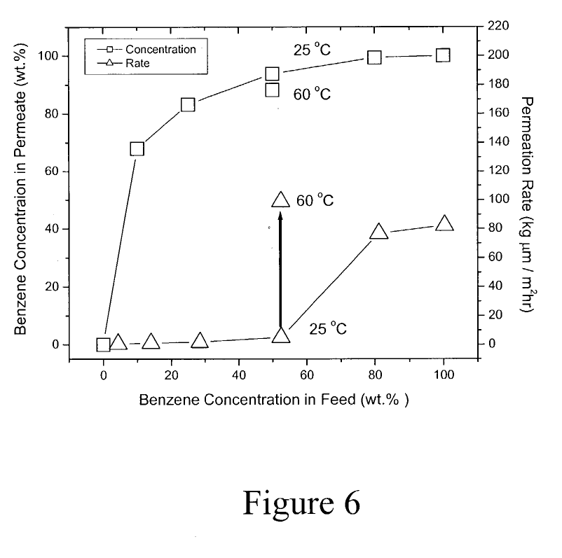

The material with the highest selectivity in FIG. 5 was blend 316. Blend 316 was, therefore, investigated across different compositions of the benzene cyclohexane feed mixture. The results of several such studies are presented in FIG. 6. FIG. 6 also presents one data set for the 316 blend separating a 50:50 mixture at a temperature of 60° C. Increasing the temperature from 25 to 60° C. results in a relatively small decrease in permeate concentration (from about 93.9 to 88.3 wt. %) but to an enormous increase in permeation rate of nearly a factor of twenty (from about 5.0 to 98.9 kg μm/m² hr). From a practical perspective these results indicate that the azeotropic composition in the benzene-cyclohexane system can be enriched to greater than 85 wt. % at a productivity of nearly 10 (kg / m² hr) utilizing a 10 μm permselective layer of the optimised blend. It is believed that this is the highest fluxing material able to achieve this level of separation reported to date.

The present inventors have further discovered that a predictive approach to the formulation of blended polymer membranes of the present invention can be pursued through the utilization of group contribution methods. In particular, the UNIFAQ-FV model of Oishi and Prausnitz has been adopted to describe solubility of, for example, benzene and cyclohexane in the polymer blends of the present invention. See Oishi, T.; Prausnitz, J. Ind. Eng. Chem. Process Des. Dev. 1978, 17, 333-339, the disclosure of which is incorporated herein by reference.

The UNIFAQ model was initially established for liquid-vapor equilibrium calculations and then extended to predict phase behavior for polymer mixtures and solutions. In this extended model, known as UNIFAQ-FV, the activity of a solution consists of three contributions.

1n a^{Total}=1n a^{C}+1n a^{R}+1n a^{FV} (9)

Here, a^{Total} is the activity of a component, a^{C} represents the combinatorial contribution, a^{R} is a residual contribution and a^{FV} is the free-volume contribution to the total activity. The combinatorial contribution is an entropic mixing factor based on differences in the size and shape of dissimilar molecules.

$$ln {a}_{j}^{C} = ln ϕ + 1 - {\sum }_{j = 1}^{q} {ϕ}_{j} \qquad ( 10 )$$

where φⱼ represents the volume fraction of species j. The residual factor represents the enthalpy exchange between two groups.

$$ln {a}_{j}^{R} {\sum }_{k} {v}_{k}^{j} [ ln {Γ}_{k} - ln {Γ}_{k}^{j} ] \qquad ( 11 )$$

where v^{j}ₖ is the number of groups of type k in molecule j, Γₖ is the group residual activity, and Γ^{j}ₖ is the group residual activity in a reference solution containing only molecules of type j. Finally, the free volume factor is given by Equation 12.

$$ln {a}^{FV} = 3 {c}_{1} ln [ \frac{{\tilde{v}}_{1}^{1 / 3} - 1}{{\tilde{v}}^{1 / 3} - 1} ] - {c}_{1} \{ {[ \frac{{\tilde{v}}_{1}}{\tilde{v}} - 1 ] [ 1 - \frac{1}{{\tilde{v}}_{1}^{1 / 3}} ]}^{- 1} \} \qquad ( 12 )$$

where \tilde{v} is reduced volume fraction, and 3c₁ is the number of external degree of freedom per solvent molecule (for hydrocarbons this value is 1.1 An advantage of a group contribution methodology is that predictions about the relative solubilities of various compounds in a polymer blend can be made without the need for any data. Utilizing this approach allows for the formulation an optimal blend composition for arbitrary mixtures based on a solubility selectivity approach. The benefit of the group contribution methodology is apparent when examining the present pervaporation data.

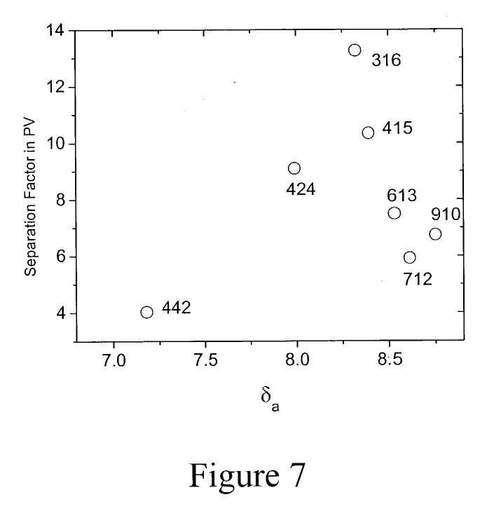

FIG. 7 sets forth pervaporation selectivity results as a function of solubility parameter δₐ for the polymer blends of the present invention. In FIG. 7 individual polymer blends are labeled. It is seen that the description of performance utilizing solubility parameters, while useful, is inadequate. A non-monotonic relationship is found.

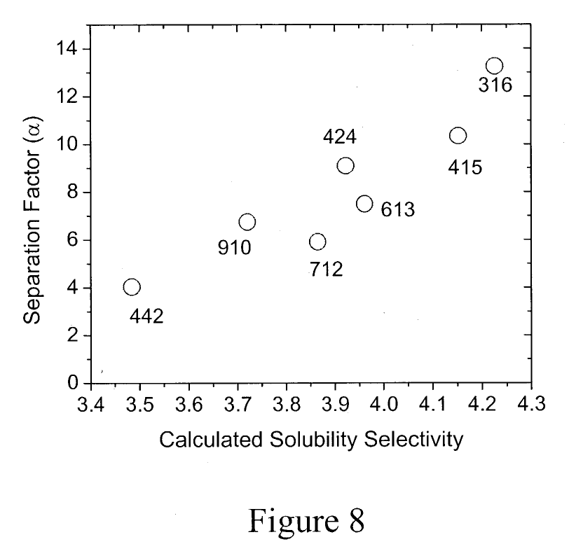

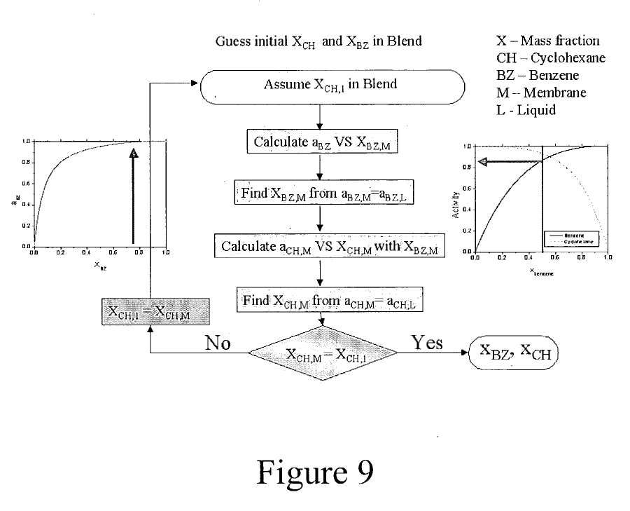

A much more satisfactory predictive description of performance is possible utilizing the UNIFAQ-FV model as evidenced in FIG. 8. In this case, the equilibrium solubilities of benzene and cyclohexane were calculated using the UNIFAQ-FV model. That is, the phase equilibrium problem specified in Equation 5 has been solved for c_{io,m} for both benzene and cyclohexane. The solution is an iterative calculation as the equilibrium concentration of benzene is affected by the concentration of cyclohexane and vice versa. A flow chart for such an iterative calculation for a 50:50 mixture of benzene and cyclohexane is set forth in FIG. 9. From the equilibrium concentrations, solubility selectivity can be calculated. The correlation between measured membrane performance and calculated selectivity was found to be good.

FIG. 8 illustrates that the UNIFAQ-FV model provides a rigorous manner of screening blend formulations in an a priori fashion. There exists a well-posed optimization problem for any separation of organic liquids in which it is desired to maximize solubility differences. Utilizing a group contribution method, solubility selectivities can be calculated as the blend formulation is changed. FIG. 8 demonstrates that such a calculation does in fact reveal the optimal formulation of the blend. At a minimum, the approach can distinguish, in an a priori fashion, promising blend formulations in a quantitative way and thus reduce the number of needed experiments during membrane development.

In the rubbery polymer blends of the present invention, permeation is largely influenced by solubility. The above results indicated that the substantial knowledge of polymer solution thermodynamics can be brought to bear in predicting solubility selectivities. In the absence of any experimental data or simulation data, group contribution methods provide reasonable predictions of solubility selectivity. Group contribution methods model thousands of organic compounds utilizing only dozens of function groups (for example, —COOH, CH₃, NH₂ etc.).

The lack of better quantitative agreement in FIG. 8 is also of interest. Differences in diffusivity between benzene and cyclohexane may play a role in the actual pervaporation performance. The results of FIG. 2 show that the pure component diffusivities differ by a factor of 5 in blend 712. On the downstream side of the membrane where penetrant concentrations are low, diffusion selectivity may become dominant. Accordingly, the blend composition should be chosen to maximize overall pervaporation, perstraction, reverse osmosis, vapor or gas separation performance.

Gas Separation Studies

The polymer membrane alloys of the present invention can also be used to effect separation of gases. Gas permeation studies of polymer blends of NBR, SBR and. PVC of the present invention were conducted using laboratory scale equipment consisting of a Millipore membrane holder having an effective membrane area in contact with the feed gas of 13.8 cm². Both sides of the membrane were evacuated to near zero pressure (a few militorr). The feed side of the membrane was then pressurized with a pure gas at a pressure of about 1 atmosphere (760 torr). Permeate side pressure was measured using a pressure transducer. Pure gas permeabilities (volume of permeated gas times membrane thickness per unit membrane area per unit time per unit pressure) were calculated from the data and reported in terms of Barrers (1 Barrer=10⁻¹⁰ (cm³(STP) cm/cm² s cmHg). For gas separations, the ideal membrane selectivity of species i over species j is defined according to Equation 13

$${α}_{G , ij} = \frac{{P}_{i}}{{P}_{j}} \qquad ( 13 )$$

where Pᵢ and Pⱼ represent the pure gas permeabilities of the respective species. Table 2 lists measured gas permeabilities and some gas selectivities for binary mixtures.

TABLE 2

| | Permeability (Barrers) | | | | | | | Ideal Selectivity | | | | | | | |
|---|---|---|---|---|---|---|---|---|---|---|---|---|---|---|---|
| Alloy | H₂ | Ar | N₂ | O₂ | H₂S | CH₄ | CO₂ | H₂/H₂S | H₂/CO₂ | H₂/CH₄ | CO₂/O₂ | CO₂/CH₄ | H₂S/CH₄ | O₂/N₂ | N₂/CH₄ |
| 442 | 8.3 | 2.4 | 0.8 | 1.01 | 6.4 | 0.5 | 2.5 | 1.3 | 3.3 | 16.6 | 2.5 | 5.0 | 12.8 | 1.3 | 1.6 |
| 316 | 5.4 | 1.4 | 0.6 | 0.7 | 0.4 | 2.01 | 1.4 | 13.5 | 3.9 | 2.7 | 2.0 | 0.7 | 0.2 | 1.2 | 0.3 |
| 613 | 6.2 | 0.7 | 0.5 | 1.01 | 4.2 | 0.8 | 3.3 | 1.5 | 1.9 | 7.8 | 3.3 | 4.1 | 5.3 | 2.0 | 0.6 |
| 712 | 5.5 | 6.7 | 3.6 | 2.7 | 0.4 | 1.01 | 1.4 | 13.8 | 3.9 | 5.4 | 0.5 | 1.4 | 0.4 | 0.8 | 3.6 |
| 424 | 4.6 | 2.3 | 1.2 | 0.9 | 0.5 | 0.7 | 0.8 | 9.2 | 5.8 | 6.6 | 0.9 | 1.1 | 0.7 | 0.8 | 1.7 |

From Table 2 it is, for example, seen that a polymer blend formulation of about 712 preferentially permeates nitrogen from methane and is thus useful for upgrading natural gas containing significant quantities of nitrogen.

Membrane Fabrication

The polymer blends or alloys of the present invention can contain either one, two, or more phases. Blend formulations leading to complete miscibility with uniform permeation properties are typically preferred. Such blends are characterized by a single glass transition temperature. However, two phase systems having inclusions of one phase (the minor phase) in another (the major phase) or of bicontinuous phases (commingled phases, each of which is continuous in space throughout the membrane) are also possible. Such blends are characterized by two or more glass transition temperatures. In such cases, the different phases may have different permeability characteristics leading to advantageous properties of the composite two phase system. Examples in the case of a blend of NBR, SBR and PVC include mixtures of at least one of NBR, SBR, and PVC with inclusions of at least one of NBR, SBR, and PVC. In other embodiments other inclusions can be added comprising, for example, solid particle fillers. Examples include mixtures of at least one of NBR, SBR, and PVC with inclusions comprising zeolites, clays, carbon black, silica, talc, titanium dioxide, crown ethers, cyclodextrans, or other inorganic or organic fillers. Also, three phase systems comprising mixtures of at least one of NBR, SBR, and PVC with inclusions of at least one of NBR, SBR, and PVC with the addition of inclusions comprising zeolites, clays, carbon black, silica, talc, crown ethers, cyclodextrans, or other inorganic or organic fillers can be utilized. The use of inert inorganic fillers is known to reduce both solubility and permeation rate similarly to increasing crosslinking thereby providing a mechanism for enhanced selectivity.

As described above, fabrication methods of the present invention are designed to produce polymer blends or alloys with variable physical and chemical characteristics. In the representative studies of the present invention, solubility parameters and permeate activity were controlled by blending three kinds of polymers using melt blending or solution blending. The blended polymers were crosslinked for the enhancement of both mechanical strength and chemical stability of the membrane. Crosslinking is important in controlling both flux and selectivity. It was found that increasing the degree of crosslinking, as for example revealed by measurements of the rubbery modulus, decreased solubility and flux but increased selectivity in the benzene cyclohexane system. The amounts and types of curative (sulfur systems, peroxides, etc.) added can, for example, be used to control the degree of crosslinking. The degree of crosslinking is also important in controlling mechanical properties, thermal stability, and solvent resilience of the membrane materials. These blended polymers can be processed from solution to form permselective, free-standing films.

For the preparation of polymer blend membranes of the present invention, polymers are dissolved in a solvent such as cyclohexanone, tetrahydrofuran, dichloromethane and/or butanone. Other solvents or solvent systems can also be used. The concentration of the polymer solutions ranged from about 1% to about 50% by weight depending on the molecular weight of the polymers used. Alternatively, the blends can be processed in the melt state without the aid of a solvent to form films, sheets, hollow fibers, or any other desirable membrane geometry.

To crosslink the polymer blend, sulfur, 2,2′-dithiobis(benzothiazole) and ZnO were added to the solution. Preferred concentrations of sulfur range from about 0.1 to about 15 parts per hundred. More preferred concentrations range from 1 to 5 parts per hundred. Sulfurless vulcanization by the use of thiuram disulfide or with selenium or tellurium is also possible. Formulations useful for crosslinking the blends may include other vulcanizing agents such as peroxides (including, but not limited to, dicumyl peroxide, benzoyl peroxide, 2,5-bis(t-butylperoxy)-2,5-dimethylhexane, and Zinc peroxide), metal oxides (including, but not limited to, zinc oxide (ZnO), litharge (PbO), magnesia (MgO) and magnesia/pentaerhthritol), and difunctional compounds (including, but not limited to, dithio compounds, diamines, quinone dioximes, and epoxys). These formulations can include other accelerators such as zinc sterate, steric acid, amines such as hexamethylene tetraamine, guanidines such as diphenyl guanidine, thioureas such as ethylenethiourea, thiazoles such as 2-mercaptobenzo-thiazole and benzothiazole disulfide, thiurams such as tetramethylthiuram disulfide, sulfenamides such as N-cyclohexyl-2-benzothiazole sulfenamide, and xanthates such as dibutylxanthogen disulfide and zinc isopropyl xanthate. The formulations can further include other activators such as inorganic compounds (including, for example, zinc oxide, zinc state, hydrated lime, litharge, red lead, white lead, magnesium oxide, alkali carbonates, and hydroxides), organic acids (including, for example, steric acid, oleic acid, lauric acid, palmitic acid, myristic acid, and hydrogenated oils from palm, castor, fish and linseed oils), and/or alkaline substances (including, for example, ammonia, amines, salts of amines with weak acids) Alternatively, gamma radiation, x-rays, electron beam, or uv radiation can be used to affect crosslinking.

In addition to crosslinking agents, anti-aging agents and antidegradants can be added to the polymer blends of the present invention to improve performance and extend the service life of the membrane. These additives include, for example, chemical protectants like secondary amines, phenolics, and phosphates. The polymer blends of the present invention can also include physical protectants such as wax. The polymer blend formulations of the present invention can also include antioxidants such as hindered phenols and bis-phenols (including, for example, styrenated phenol and 2,2′-methylene-bis-(4 methyl-6-t-butyl-phenol)), amino-phenols (including, for example, 2,6′-di-t-butyl-(x-dimethylamino-p-cresol), hydroquinones (including, for example 2,5-di-t-amyl hydroquinone), phosphites (including, for example, mono-, di-, and trinonylphenyl phosphites), diphenylamines (including, for example, octylated diphenyl-amine), naphthylamines (including, for example, phenyl-β-naphthyl-amine), alkyldiamines (including, for example, N,N′-diphenyl-ethylene diamine), aldehyde-amine condensation products (including, for example, acetone-diphenyl-amine reaction product), quinoline (including, for example, polymerized 2,2,4-trimethyl-1,2-dihydroquinoline) and phenylenediamine (including, for example, N,N′-diphenyl-p-phenylene diamine). The polymer blend membranes of the present invention can also include antiozonants such as dialkyl-phenylene diamines (including, for example, N,N′-bis(1-methyl-heptyl)-p-phenylene-diamine), alkyl-aryl-phenylene-diamines (including, for example, N-isopropyl-N′-phenyl-p-phenylene diamine), carbamates (including, for example, nickel dibutyldithio-carbamate), and waxes (including, for example, petroleum and microcrystalline waxes).

Other ingredients can also be incorporated into the polymer blend membranes of the present invention to improve performance, extend service life, or facilitate fabrication. These include, but are not limited to, plasticizers such as fatty acids (for example, fatty acids from cotton seed, rincinoleic, lauric), vegetable oils (such as sulfonated oils, gelled oils, soy oils, tall oil, solid soya, and soya polyesters), petroleum products (such as mineral oil, napthenic oil, paraffinic oil, aromatic oil, and certain asphalts), coal-tar products (such as coal tar pitch, soft cumars, soft-coal tar, and cumar resins), pine products (such as gum turpentine, rosin oil, rosin, pine tar, dipentene, and rosin ester), esters (such as dicapryl phthlate, butyl cuminate, dibutyl phthlate, butyl lactate, glycerol chlorobenzoate, chlorodibutyl carbonate, methyl ricinoleate, butyl oleate, dibutyl sebacate, dioctyl phthlate, methyl oleate, and tricresyl phosphate), resins (such as coumarone-indene, phenol-formaldehyde, and shellac) and other miscellaneous compounds (for example, amines, wool grease, pitches, diphenyl oxide, benzoic acid, benzyl polysulfide, waxes, castor oil, low molecular weight polyethylene, and vulcanized vegetable oil). The membrane polymer blends of the present invention can also include tackifiers (for example, coumarone-indene resins, ester gum, and oil-soluble phenolic resin).

Rubbery polymers suitable for use in the present invention include, but are not limited to, natural rubber, polybutadiene, polyisoprene, halogenated butadienes such as polychlorobutadiene (chloprene rubber), chlorinated polyethylene (CM), chlorosulfonated polyethylene, poly(epichlorohydrin) (CO), polybutylmethacrylate, polydimethyl siloxane, polydimethylphenylsiloxane, flurosiloxane rubber from the reaction of methyl-trifluoropropyl siloxane, and polysulfide rubbers. Additional rubbery copolymers suitable for use in the present invention include, but are not limited to, hydrogenated acrylonitrile butadiene copolymers (H-NBR), acylonitrile-butadiene-styrene (ABS) copolymers, poly(epichlorohydrin), copolymers of isoprene-isobutylene, halogenated copolymers of isoprene-isobutylene such as chlorinated and brominated copolymers of isoprene and isobutylene, copolymers of ethylene and propylene (EPR), copolymers of ethylene, propylene, and dienes (EPDM), ethylene-vinylacetate copolymers (EVM), acrylic rubbers, ethylene-acrylate copolymers (ACM), copolymers of epichlorihydrin and ethylene oxide (ECO), ternary copolymers of epichlorihydrin and ethylene oxide with poly(epichlorohydrin) blocks, polypropylene oxide rubber—a copolymer of propylene oxide and allylglycidil ether, fluroelastomers comprising copolymers of hexafluoro propoylene, tetrafluro ethylene, 1-hydropentafluoro propylene, and perfluoro(methylvinylether), alkylenesulfide rubbers, polysiloxane copolymers comprising dimethyl siloxane, dimethylphenylsiloxane, and vinyl siloxane.

Glassy polymers suitable for use in the polymer blends of the present invention include, but are not limited to, polystyrene, high styrene content poly(styrene-co-butadiene) resins, polyacylonitrile, poly(vinylidenechloride), copolymers of poly(vinylidenechloride) and polyvinylchloride, poly(vinylidenefluoride), polyvinylfluoride, poly(methylmethacylate) and other acrylic polymers, polyvinyl acetate, polyamides, polyimides, polyesters, polyethers, polycarbonates, blends of polycarbonate with ABS copolymers, poly(phenylene sulfide), polysulfones, polysulfides, and polyether sulfone.

Preferred concentrations of the casting solutions of the present invention range from about 5% to about 15% by weight. In several of the studies of the present invention, the solution was cast onto a glass plate using a Gardner Knife to form a defect-free liquid film. The solvent was then evaporated by heating the film. Preferably, evaporation of the solvents was carried out at a temperature ranging from about 25° C. to about 100° C. After evaporating the solvent, a dense, defect-free film of the alloy was formed. The thickness of the film depended on the viscosity of the polymer solution and the initial thickness of the polymer solution film cast. In addition, an asymmetric or partially porous membrane could be constructed rather than a dense film. Different methods of forming the thin rubber film can be practiced including continuous extrusion from an extruder or other mixing device and hot pressing. Additionally, hollow fiber membranes can be prepared either from solution spinning (forming a hollow fiber from a solution) or by melt spinning (making hollow fibers from a melt of the blend without dissolving the polymer components into a solvent).

In the studies of the present invention, the film was then crosslinked by heat treatment, preferably at a temperature ranging from about 70° C. to about 180° C., and more preferably, at temperatures ranging from about 100° C. to about 150° C., and even more preferably from about 110° C. to 140° C. The time of such heat treatment preferably ranges from about 1 minute to about 200 minutes. Alternatively, the membranes can be crosslinked in other manners as described above. After crosslinking, the polymer film was no longer soluble in the original solvent used.

The polymer alloys of the present invention can also be deposited onto porous substrates to form composite membranes. A composite of the thin dense film or asymmetric film on a porous or non-porous support layer of materials such as other polymers, metal, glass or other materials can be constructed. The construction of such composite membranes has the advantage of reducing the resistance to mass transfer by making the permselective blend membrane very thin. The effect of having a thin permselective membrane is to increase the rate at which components can be separated in gas separation, pervaporation, or perstraction operations. Increasing the rate of separation can improve the economics of the separation processes.

The foregoing description and accompanying drawings set forth the preferred embodiments of the invention at the present time. Various modifications, additions and alternative designs will, of course, become apparent to those skilled in the art in light of the foregoing teachings without departing from the scope of the invention. The scope of the invention is indicated by the following claims rather than by the foregoing description. All changes and variations that fall within the meaning and range of equivalency of the claims are to be embraced within their scope.

What is claimed is:

1. A membrane comprising a blend of two or more polymers such that under operating conditions of a separation using the membrane the operating temperature is greater than at least one glass transition temperature of the blend.

2. The membrane of claim 1 having a calculated solubility selectivity greater than 1 using a group contribution model.

3. The membrane of claim 1 having a calculated solubility selectivity greater than 2.

4. The membrane of claim 1 having a calculated solubility selectivity greater than 5.

5. The membrane of claim 1 having a calculated solubility selectivity greater than 20.

6. The membrane of claim 1 wherein the calculated δₐ of the membrane material value is greater than 7.5.

7. The membrane of claim 1 wherein the blend of polymers includes polar functional groups and non-polar functional groups and wherein the composition of the blend is selected so that the interaction of the polar functional groups and the non-polar functional groups with a permeating species leads to preferential solubility selectivity.

8. The membrane of claim 1 wherein at least one of the polymers of the blend is chosen to be a rubbery polymer having a T_{g} at atmospheric pressure less than 20° C. and at least one other of the polymers of the blend is a glassy polymer having a T_{g} at atmospheric pressure greater than 20° C.

9. The membrane of claim 8 wherein the rubbery polymer has a T_{g} less than 0° C. at atmospheric pressure.

10. The membrane of claim 8 wherein the glassy polymer has a T_{g} greater than 50° C. at atmospheric pressure.

11. The membrane of claim 8 wherein the glassy polymer has a T_{g} greater than 100° C. at atmospheric pressure.

12. The membrane of claim 1 wherein the blend of polymers comprises a first rubbery polymer having a T_{g} at atmospheric pressure less than 20° C. and at least a second rubbery polymer having a T_{g} at atmospheric pressure less than 20° C.

13. The membrane of claim 1 wherein the blend of polymers comprises a first glassy polymer having a T_{g} at atmospheric pressure greater than 20° C. and at least a second glassy polymer having a T_{g} at atmospheric pressure greater than 20° C.

14. The membrane of claim 1 wherein at least one of the polymers of the blend is acrylonitrile butadiene rubber, styrene butadiene rubber, natural rubber, polybutadiene, polyisoprene, halogenated polybutadiene; chlorinated polyethylene, chlorosulfonated polyethylene, poly(epichlorohydrin), polybutylmethacrylate, polydimethyl siloxane, polydimethylphenylsiloxane, functionalized polysiloxanes, flurosiloxane rubber, hydrogenated acrylonitrile butadiene copolymer, acylonitrile-butadiene-styrene copolymer, isoprene-isobutylene copolymer, halogenated isoprene-isobutylene copolymer, ethylene-propylene copolymer, ethylene-propylene-diene copolymer, ethylene-vinylacetate copolymer, acrylic rubber, ethylene-acrylate copolymer, epichlorihydrin-ethylene oxide copolymer, copolymers of epichlorihydrin and ethylene oxide with poly(epichlorohydrin) blocks, polypropylene oxide rubber, copolymer of hexafluoro propoylene, tetrafluro ethylene, 1-hydropentafluoro propylene, and perfluoro(methylvinylether), alkylenesulfide rubber, or polysiloxane copolymers of dimethyl siloxane, dimethylphenylsiloxane, and vinyl siloxane.

15. The membrane of claim 1 wherein at least one of the polymers is chosen to improve mechanical properties of the membrane.

16. The membrane of claim 1 wherein at least one of the polymers is chosen to control the polarity of the membrane.

17. The membrane of claim 1 wherein at least one of the polymers is a glassy thermoplastic having polar characteristics and a glass transition temperature greater than about 20° C.

18. The membrane of claim 1 wherein at least one polymer of the blend is poly(vinyl chloride), polystyrene, polyacylonitrile, poly(vinylidenechloride), copolymer of poly(vinylidenechloride) and polyvinylchloride, poly(vinylidenefluoride), polyvinylfluoride, an acrylic polymer, polyvinyl acetate, a polyamide, a polyimide, a polyester, a polyether, poly(phenylene sulfide), a polysulfone, a polysulfide, or a polyether sulfone.

19. The membrane of claim 14 wherein at least one other of the polymers of the blend is poly(vinyl chloride), polystyrene, polyacrylonitrile, poly(vinylidenechloride), copolymer of poly(vinylidenechloride) and polyvinylchloride, poly(vinylidenefluoride), polyvinylfluoride, an acrylic polymer, polyvinyl acetate, a polyamide, a polyimide, a polyester, a polyether, poly(phenylene sulfide), a polysulfone, a polysulfide, or a polyether sulfone.

20. The membrane of claim 1 wherein at least one of the polymers of the blend is crosslinked to form a polymer network.

21. The membrane of claim 19 further comprising at least a third polymer.

22. The membrane of claim 21 wherein the polymer blend comprises acrylonitrile butadiene rubber, styrene butadiene rubber and poly(vinyl chloride).

23. The membrane of claim 22 wherein at least one of the polymers is crosslinked to from a polymer network

24. The membrane of claim 21 wherein acrylonitrile butadiene rubber comprises between about 0.1 weight fraction and about 1 weight fraction of the membrane.

25. The membrane of claim 24 wherein the acrylonitrile butadiene rubber has a number average molecular weight of at least 500.

26. The membrane of claim 24 wherein the acrylonitrile butadiene rubber comprises at least about 15% acrylonitrile content.

27. The membrane of claim 21 wherein the styrene butadiene rubber comprises between about 0.01 weight fraction and about 0.5 weight fraction of the membrane.

28. The membrane of claim 27 wherein the styrene butadiene rubber has a number average molecular weight of at least 500.

29. The membrane of claim 27 wherein styrene butadiene rubber comprises at least about 20% styrene content.

30. The membrane of claim 21, wherein poly(vinyl chloride) comprises between about 0.01 weight fraction and about 0.9 weight fraction of the membrane.

31. The membrane of claim 30 wherein the poly(vinyl chloride) has a number average molecular weight of at least 500.

32. The membrane of claim 31, wherein the poly(vinyl chloride) has a number average molecular weight of at least about 30,000 (g/mol).

33. The membrane of claim 21 wherein the calculated δₐ value of the membrane is greater than 7.5.

34. The membrane of claim 21, comprising between about 0.1 weight fraction and about 1 weight fraction of acrylonitrile butadiene rubber, between about 0.01 weight fraction and about 0.5 weight fraction of styrene butadiene rubber, and between about 0.01 weight fraction and about 0.9 weight fraction of poly(vinyl chloride).

35. The membrane of claim 21, wherein the weight fractions of the polymer components are selected for separation of aromatic hydrocarbons form mixtures of aromatic and non-aromatic hydrocarbons.

36. The membrane of claim 21 having a permeation rate for a separation of a 50:50 benzene-cyclohexane mixtures at 25° C. of at least 2 kg μm/m² hr.

37. The membrane of claim 21 having a permeation rate for a separation of a 50:50 benzene-cyclohexane mixtures at 25° C. of at least 5 kg μm/m2 hr.

38. The membrane of claim 21 having a permeation rate for a separation of a 50:50 benzene-cyclohexane mixtures at 25° C. of at least 10 kg μm/m² hr.

39. The membrane of claim 21 having a permeation rate for a separation of a 50:50 benzene-cyclohexane mixtures at 25° C. of at least 20 kg μm/m² hr.

40. The membrane of claim 1, having a separation factor value for a separation of a 50:50 benzene-cyclohexane at 25° C. of at least 4.

41. The membrane of claim 1, having a separation factor value for a separation of a 50:50 benzene-cyclohexane s at 25° C. of at least 10.

42. The membrane of claim 21, having a separation factor value for a separation of a 50:50 benzene-cyclohexane at 25° C. of at least 4.

43. The membrane of claim 21, having a separation factor value for a separation of a 50:50 benzene-cyclohexane at 25° C. of at least 10.

44. The membrane of claim 1 further comprising an inorganic filler material chosen to reduce flux through the membrane and to increase selectivity.

45. A membrane comprising a blend of polymers exhibiting calculated δₐ of the membrane material value is greater than 7.5.

46. A membrane comprising a blend of polymers exhibiting a calculated solubility selectivity for a separation of interest greater than 1.

47. The membrane of claim 46 having a calculated solubility selectivity greater than 2.

48. The membrane of claim 46 having a calculated solubility selectivity greater than 5.

49. The membrane of claim 46 having a calculated solubility selectivity greater than 20.

50. A membrane comprising a blend of polymers having polar functional groups and non-polar functional groups wherein the composition of the blend is selected so that the interaction of the polar functional groups and the non-polar functional groups with a permeating species leads to preferential solubility selectivity.

51. A polymer blend for performing a separation comprising at least one rubbery polymer having a glass transition temperature no greater than 20° C. and at least one glassy polymer having a glass transition temperature above 20° C.

52. The polymer blend of claim 51 further comprising at least a second rubbery polymer having a glass transition temperature no greater than 20° C.

53. The polymer blend of claim 52 wherein the first rubbery polymer is acrylonitrile butadiene rubber, the second rubbery polymer is styrene butadiene rubber and the glassy polymer is poly(vinyl chloride).

54. The polymer blend of claim 53 wherein the acrylonitrile butadiene rubber comprises between about 0.1 weight fraction and about 1 weight fraction of the polymer blend.

55. The polymer blend of claim 54 wherein the acrylonitrile butadiene rubber has a number average molecular weight of at least 500.

56. The polymer blend of claim 54 wherein the acrylonitrile butadiene rubber comprises at least about 15% acrylonitrile content.

57. The polymer blend of claim 53 wherein styrene butadiene rubber comprises between about 0.01 weight fraction and about 0.5 weight fraction of the polymer blend.

58. The polymer blend of claim 57 wherein the styrene butadiene rubber has a number average molecular weight of at least 500.

59. The polymer blend of claim 57 wherein styrene butadiene rubber comprises at least about 20% styrene content.

60. The polymer blend of claim 53, wherein poly(vinyl chloride) comprises between about 0.01 weight fraction and about 0.9 weight fraction of the polymer blend.

61. The polymer blend of claim 60 wherein the poly(vinyl chloride) has a number average molecular weight of at least 500.

62. The polymer blend of claim 60, wherein poly(vinyl chloride) has a number average molecular weight of at least about 30,000 (g/mol).

63. The polymer blend of claim 53, wherein the calculated δₐ value of the polymer blend is greater than 7.5.

64. The polymer blend of claim 53, comprising between about 0.1 weight fraction and about 1 weight fraction of acrylonitrile butadiene rubber, between about 0.01 weight fraction and about 0.5 weight fraction of styrene butadiene rubber, and between about 0.01 weight fraction and about 0.9 weight fraction of poly(vinyl chloride).

65. The polymer blend of claim 51, wherein the weight fractions of the polymer components are selected for separation of aromatic hydrocarbons form mixtures of aromatic and non-aromatic hydrocarbons.

66. The polymer blend of claim 51, having a separation factor value for benzene-cyclohexane separations at 25° C. of at least 4.

67. The polymer blend of claim 51, having a separation factor value for benzene-cyclohexane separations at 25° C. of at least 10.

68. The polymer blend of claim 53, having a separation factor value for benzene-cyclohexane separations at 25° C. of at least 4.

69. The polymer blend of claim 53, having a separation factor value for benzene-cyclohexane separations at 25° C. of at least 10.

70. A method of producing a polymer alloy capable of separating chemicals, the polymer alloy comprising a polymer blend of at least one of acrylonitrile butadiene rubber and styrene butadiene rubber, and poly(vinyl chloride), comprising the steps:
a. dissolving at least one of acrylonitrile butadiene rubber and styrene butadiene rubber with poly(vinyl chloride) in a solvent to form a polymer solution;
b. adding at least one compound to the polymer solution to form a casting solution;
c. casting the casting solution to form a cast polymer;
d. evaporating the solvent from said cast polymer to form a polymer film; and,
e. crosslinking the polymer film to form a cast polymer alloy.

71. The method of claim 70 wherein sulfur, 2,2′-dithiobisbenzothiazole and zinc oxide are added to the polymer solution to form a casting solution.

72. The method of claim 70, wherein the polymer solution comprises between about 0.1 weight fraction and about 1 weight fraction of acrylonitrile butadiene rubber, between about 0.01 weight fraction and about 0.5 weight fraction of styrene butadiene rubber, and between about 0.01 weight fraction and about 0.9 weight fraction of poly(vinyl chloride).

73. The method of claim 70, wherein the solvent is cyclohexanone, tetrahydrofuran, dichloromethane of butanone.

74. The method or claim 70, wherein the concentration of the polymer solution is between about I weight percent and about 50 weight percent.

75. The method of claim 67, wherein the casting solution is cast onto a glass, metal, plastic, ceramic or other type of flat or curved surface to form a liquid film.

76. The method of claim 70, wherein the casting solution is cast into an asymmetric porous membrane.

77. The method of claim 70, wherein the casting step comprises solution spinning to form a hollow fiber membrane.

78. The method of claim 70, wherein the casting step comprises melt spinning to form a hollow fiber membrane.

79. The method of claim 70, wherein the casting step comprises continuous extrusion and curtain coating.

80. The method of claim 70, wherein the evaporating step comprises heating the cast polymer at a temperature between about 25° C. and about 100° C.

81. The method of claim 70, wherein the crosslinking step comprises heating the polymer film to a temperature between about 70° C. and about 180° C.

82. The method of claim 81, wherein the polymer film is heated to a temperature between about 100° C. and about 150° C.

83. The method of claim 82, wherein the polymer film is heated for a time ranging from about 1 minute to about 200 minutes.

84. The method of claim 70, wherein the crosslinking step comprises chemical crosslinking by the addition of a member of the group consisting of peroxides, sulfur, sulfur-containing agents, zinc oxide, and zinc stearate.

85. The method of claim 70, wherein the crosslinking step comprises a variation of chemical crosslinking selected from the group consisting of sulfur vulcanization, carbamate modified crosslinking and UV-crosslinking.

86. The method of claim 70, wherein the crosslinking step comprises a variation of radiation crosslinking selected from the group consisting of gamma radiation, electron beam, and x-ray crosslinking.

87. The method of claim 70, wherein the casting step comprises depositing said casting solution on a substrate to form a composite polymer membrane material.

88. The method of claim 87, wherein the substrate comprises a material selected from the group consisting of metals, glasses, ceramics, other polymers and mixtures thereof.

89. A method of producing a polymer alloy capable of separating chemicals comprising a polymer blend of at least one of acrylonitrile butadiene rubber and styrene butadiene rubber and poly(vinyl chloride), comprising the steps:
a. melting the polymer blend;
b. processing the melted polymer blend to form a membrane; and
c. crosslinking the membrane.

90. The method of claim 89, wherein the melted polymers are formed into a selected geometry.

91. The method of claim 89, wherein the melted polymers are formed into a film, a sheet, or a hollow fibers.

92. A method of separating components in a mixture comprising the step of contacting the mixture with a membrane, the membrane comprising a blend of polymers wherein under operating conditions of a separation the operating temperature is greater than at least one glass transition temperature of the blend.

93. The method of claim 92 wherein the separation of the components of the mixture is effected based at least in part upon differences in solubility of the components to be separated in the membrane.

94. The method of claim 92 wherein aromatic hydrocarbon components are separated from non-aromatic hydrocarbon components.

95. The method of claim 92 wherein polar components are separated from less polar components.

96. The method of claim 92 wherein the components to be separated are gases.

97. The method of claim 92 wherein membrane comprises acrylonitrile butadiene rubber, styrene butadiene rubber, and poly(vinyl chloride).

98. The method of claim 92 wherein the separation is a vapor separation, a gas separation, a pervaporation separation, a perstraction separation, or a reverse osmosis separation.
